(19) United States
(12) Patent Application Publication
(10) Pub. No.: US 2021/0255365 A1
(43) Pub. Date: Aug. 19, 2021

(54) ANTI-GLARE FILM AND POLARIZER WITH THE SAME

(71) Applicant: BenQ Materials Corporation, Taoyuan (TW)

(72) Inventors: TsunSheng Tao, Taoyuan (TW); Chih-Wei Lin, Taoyuan (TW); Kuo-Hsuan Yu, Taoyuan (TW)

(21) Appl. No.: 16/995,962

(22) Filed: Aug. 18, 2020

(30) Foreign Application Priority Data
Feb. 13, 2020 (TW) 109104551

(51) Int. Cl. G02B 1/111; G02B 1/14

(52) U.S. Cl. CPC G02B 1/111; G02B 1/14

(57) ABSTRACT

The present invention is to provide an anti-glare film. The anti-glare film comprises a transparent substrate and an anti-glare layer formed on a surface of the substrate, wherein the anti-glare coating layer comprises 75 to 90 weight percent of an acrylic-based hard coating composition, 0.01 weight percent to 10 weight percent of silica nanoparticles and 5 weight percent to 20 weight percent of organic microparticles. The anti-glare film provides a satisfied anti-glare property and a surface fineness, and especially the anti-glare property at the wide viewing angle to enhance the visibility of the display.

### CROSS-REFERENCE TO RELATED APPLICATION

This application claims the priority benefit of Taiwanese Application Serial Number 109104551, filed Feb. 13, 2020 which is incorporated herein by reference.

### TECHNICAL FILED

The present invention relates to an anti-glare film for display and a polarizer with the same.

### BACKGROUND OF THE INVENTION

With the increasingly development of display technology, the performance requirements of a display, such as liquid crystal displays (LCD) or organic light-emitting diode displays (OLED), such as, high contrast, wide viewing angle, high brightness, thinning, larger-sized, high-resolution and diversified additional functions are proposed.

An anti-reflective film or an anti-glare film is used on the surface of the display to prevent the visibility of the image from decreasing. It is known that the roughness of the anti-glare film is used to achieve the anti-glare effect of light diffusion, but increasing the surface roughness in order to enhance the anti-glare property will cause the opacity of the anti-glare layer, resulting in the decline of the visibility and contrast of the display. On the other side, with the development of high-resolution liquid crystal displays, the anti-glare film used in high-resolution displays requires a fine surface to prevent the clarity of the image from being affected, but this causes the external light to reflect on the display surface and brings the whitening of the display surface, and furthermore, when the light generated by the internal backlight of the display passing through the anti-glare film on the display surface, the fine surface of the display may cause the light to be reflected internally and result in the uneven brightness and poor visibility of the display.

Moreover, when the high-haze anti-glare film is installed on the display surface, it is difficult to provide both anti-glare and whitening-prevention features, and may decrease the color reproducibility or sharpness during display, furtherly affecting the contrast of the display in expect.

The present invention provides an anti-glare film for liquid crystal displays, which provides a satisfied anti-glare property and a surface fineness, and especially the anti-glare property at the wide viewing angle to enhance the visibility of the display.

### SUMMARY OF THE INVENTION

An object of the present invention is to provide an anti-glare film comprising a transparent substrate and an anti-glare hard coating layer that is formed on a surface of the transparent substrate. The anti-glare hard coating layer comprises 75 to 90 weight percent of the acrylic-based hard coating composition, 0.01 to 10 weight percent of silica nanoparticles and 5 to 20 weight percent of organic microparticles. The gloss of the anti-glare film at a viewing angle of 60 degrees is between 30% and 50%.

The total haze of the present anti-glare film is ranging between 40% and 50%, the internal haze is ranging between 28% and 40% and the surface haze is ranging between 10% and 13% thereof.

In the anti-glare film of the present invention, the average particle diameter of the organic microparticles used in the anti-glare hard coating layer is ranging from 1 μm to 6 μm and preferably ranging from 2 μm to 5 μm, and the usage amount of the organic microparticles is preferably between 7 and 15 weight percent.

In the anti-glare film of the present invention, the average primary particle diameter (d₅₀) of the silica nanoparticles used in the anti-glare hard coating layer is ranging from 5 nm to 30 nm and the average secondary particle diameter (d₅₀) thereof is ranging from 50 nm to 120 nm. The usage amount of the silica nanoparticles is preferably between 0.05 and 7 weight percent.

In the anti-glare film of the present invention, a leveling agent of 0.05 to 2 weight percent can be further added to the anti-glare hard coating layer.

In the anti-glare film of the present invention, the acrylic-based hard coating composition of the anti-glare hard coating layer comprises (meth)acrylate compositions and an initiator, wherein the (meth)acrylate composition comprises the polyurethane (meth)acrylate oligomer of 35 to 50 weight percent with a functionality of 6 to 15, the (meth)acrylate monomer of 12 to 20 weight percent at least one with a functionality of 3 to 6 and the (meth)acrylate monomer of 1.5 to 12 weight percent at least one with a functionality less than 3, wherein the molecular weight of the polyurethane (meth)acrylate oligomer is ranging from 1000 to 4500.

A further object of the present invention is to provide a method for preparing an anti-glare film, wherein the method comprises the steps of, mixing the acrylic-based hard coating composition and the organic microparticles evenly to form an anti-glare hard coating layer solution; coating the anti-glare hard coating layer solution on the transparent substrate; drying and curing the coated substrate to form an anti-glare film.

A yet object of the present invention is to provide a polarizer comprising a polarizing element and an anti-glare film as above-disclosed formed thereon.

The above and other aspects of the invention will become better understood with regard to the following detailed description of the preferred but non-limiting embodiment(s). These and other aspects of the invention will become apparent from the following description of the presently preferred embodiments. The detailed description is merely illustrative of the invention and does not limit the scope of the invention, which is defined by the appended claims and equivalents thereof. As would be obvious to one skilled in the art, many variations and modifications of the invention may be affected without departing from the spirit and scope of the novel concepts of the disclosure.

### DETAILED DESCRIPTION OF THE INVENTION

In the following detailed description, for purposes of explanation, numerous specific details are set forth in order to provide a thorough understanding of the disclosed embodiments. It will be apparent, however, that one or more embodiments may be practiced without these specific details.

It is apparent that departures from specific designs and methods described and shown will suggest themselves to those skilled in the art and may be used without departing from the spirit and scope of the invention. The present invention is not restricted to the particular constructions described and illustrated, but should be construed to cohere with all modifications that may fall within the scope of the appended claims.

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well-known and commonly employed in the art.

The term “(meth)acrylate” used herein refers to acrylate or methacrylate. The average primary particle size (d₅₀) of the particles refers to the particle size corresponding to the cumulative fineness distribution of the original particles reaching 50%. The average secondary particle size (d₅₀) of the particles refers to the particle size corresponding to the secondary cumulative fineness distribution of the agglomerate of original particles reaching 50%.

An object of the present invention is to provide an anti-glare film comprising a transparent substrate and an anti-glare hard coating layer that is formed on a surface of the transparent substrate. The anti-glare hard coating layer comprises 75 to 90 weight percent of the acrylic-based hard coating composition, 0.01 to 10 weight percent of silica nanoparticles and 5 to 20 weight percent of organic microparticles. The gloss of the anti-glare film at a viewing angle of 60 degrees is between 30% and 50%.

The total haze of the present anti-glare film is ranging between 40% and 50%, the internal haze is ranging between 28% and 40% and the surface haze is ranging between 10% and 13% thereof.

In a preferred embodiment of the present invention, the transparent substrate suitably used in the anti-glare film of the present invention can be the film with good mechanical strength and light transmittance. The examples of the substrate can be but not limited to triacetate cellulose (TAC), polymethyl methacrylate (PMMA), polyethylene terephthalate (PET), polycarbonate (PC), polyimide (PI), polyethylene (PE), polypropylene (PP), polyvinyl alcohol (PVA), polyvinyl chloride (PVC) or cyclic olefin copolymer (COC) and the like.

In an embodiment of the anti-glare film of the present invention, the light transmittance of the transparent substrate is more than 80% and preferably is more than 90%. The thickness of the transparent substrate is ranging between 10 μm and 250 μm, and preferably ranging between 20 μm and 100 μm.

In an embodiment of the present invention, the thickness of the anti-glare hard coating layer is ranging from 2 μm to 10 μm, and preferably ranging from 3 μm to 9 μm, and more preferably ranging between 4 μm and 7 μm.

The anti-glare hard coating layer of the present anti-glare film comprises organic microparticles and silica nanoparticles, wherein the addition of organic microparticles provides a light diffusion effect of an anti-glare hard coating layer, and give an appropriate internal haze to homogenize the light emitted from the display. The refractivity, particle size and addition amount of the selected organic microparticles can adjust the internal haze of the present anti-glare film. The refractivity of the suitable organic microparticles of the present invention is ranging between 1.49 and 1.60, and the average particle diameter thereof is ranging from 1 μm to 6 μm and preferably ranging from 2 μm to 5 μm. The usage amount of the organic microparticles is ranging between 5 to 20 weight percent and preferably ranging between 7 to 15 weight percent. When the usage amount of the organic microparticles is insufficient, the light diffusion effect of an anti-glare film will be reduced, and the display can easily affected by the light reflection of the external light, which reduces the display quality. When the usage amount of the organic microparticles is excess, the light scattering effect of the anti-glare film will be over, and the display image can be prone to whitening and the contrast reduction of display may be occurred.

The suitable organic microparticles are polymethyl methacrylate resin microparticles, polystyrene resin microparticles, styrene-methyl methacrylate copolymer microparticles, polyethylene resin microparticles, epoxy resin microparticles, and silicone resin microparticles, polyvinylidene fluoride resin or polyvinyl fluoride resin microparticles, and its can be hydrophilic or hydrophobic. The organic microparticles can be selected from resin microparticles comprising styrene groups, or the organic microparticles are hydrophilic treated by, such as 2-hydroxyethyl(meth)acrylate (2-HE(M)A) or (meth)acrylonitrile.

In an embodiment of the anti-glare film of the present invention, the anti-glare hard coating layer comprises silica nanoparticles and the addition of the silica nanoparticles can promote the anti-settling of organic microparticles and increase the surface fineness of the anti-glare hard coating layer. The suitable average primary particle diameter (d₅₀) of the silica nanoparticles is ranging from 5 nm to 30 nm and the average secondary particle diameter (d₅₀) thereof is ranging from 50 nm to 120 nm. The usage amount of the silica nanoparticles is ranging between 0.01 and 10 weight percent and preferably ranging between 0.05 and 7 weight percent. When the usage amount of the silica nanoparticles is insufficient, the settle of the organic microparticles cannot be prevented, and the surface unevenness on the anti-glare film cannot be appropriately provided to increase the fineness. When the usage amount of the silica nanoparticles is excess, the dispersibility of the silica nanoparticles will be declined, which increase the haze of the anti-glare film and result in whitening and contrast reduction of the display.

In the anti-glare film of the present invention, a leveling agent of 0.05 to 2 weight percent can be further added to the anti-glare hard coating layer. The addition of the leveling agent provides the uniform surface of the anti-glare hard coating layer, which bring about surface lubricity, stain resistance and abrasion resistance after the anti-glare hard coating layer be coated and cured. The suitable leveling agent can be a fluorine-based or silicone-based leveling agent, such as silicone oil or fluorine-based surfactant, preferably a leveling agent comprising polyether modified polysiloxane.

The suitable leveling agent for the anti-glare hard coating layer of present anti-glare film, such as polyether modified polysiloxane, is used in an amount ranging between 0.05 to 2 weight percent and preferably ranging between 0.5 to 1 weight percent. When the usage amount of the leveling agent is insufficient, the anti-glare hard coating layer may lack of leveling effect and the drying defects will occur during coating. When the usage amount of the leveling agent is excess, the excessive leveling agent will produce micelles in the anti-glare hard coating layer, reducing the physical properties of the anti-glare film.

In the anti-glare film of the present invention, the acrylic-based hard coating composition of the anti-glare hard coating layer comprises (meth)acrylate compositions and an initiator, wherein the (meth)acrylate composition comprises the polyurethane (meth)acrylate oligomer of 35 to 50 weight percent with a functionality of 6 to 15, the (meth)acrylate monomer of 12 to 20 weight percent at least one with a functionality of 3 to 6 and the (meth)acrylate monomer of 1.5 to 12 weight percent at least one with a functionality less than 3, wherein the molecular weight of the polyurethane (meth)acrylate oligomer is ranging from 1000 to 4500. The mentioned hard coating provides good adhesion with the PET substrate, good weather resistance, sufficient surface hardness and abrasion resistance.

In an embodiment of the present invention, the molecular weight of the polyurethane (meth)acrylate oligomer with a functionality of 6 to 15 is not less than 1,000 and preferably ranging between 1,500 and 4,500. In a preferred embodiment of the present invention, the polyurethane (meth)acrylate oligomer with a functionality of 6 to 15 is an aliphatic polyurethane (meth)acrylate oligomer with a functionality of 6 to 15.

In an embodiment of the present invention, the molecular weight of the (meth)acrylate monomer with a functionality of 3 to 6 is less than 1,000 and preferably ranging less than 800. The suitable (meth)acrylate monomer with a functionality of 3 to 6 is selected from, such as, but not limited to, at least one of a group consisting of pentaerythritol tetra(meth)acrylate, dipentaerythritol penta(meth)acrylate (DPP(M)A), dipentaerythritol hexa(meth)acrylate (DPH(M)A), trimethylolpropane tri(meth)acrylate (TMPT(M)A), ditrimethylolpropane tetra(meth)acrylate (DTMPT(M)A), pentaerythritol tri(meth)acrylate (PET(M)A) or combinations thereof, and preferably one selected from pentaerythritol triacrylate (PETA), dipentaerythritol hexaacrylate (DPHA), dipentaerythritol pentaacrylate (DPPA) or combinations thereof.

In an embodiment of the present invention, the (meth)acrylate monomer with a functionality less than 3 is the (meth)acrylate monomer with a functionality of 1 or 2, and the molecular weight thereof is less than 500. The suitable (meth)acrylate monomer with a functionality less than 3 is selected from, such as at least one of a group consisting of 2-ethylhexyl (meth)acrylate (2-EH(M)A), 2-hydroxyethyl (meth)acrylate (2-HE(M)A), 3-hydroxypropyl (meth)acrylate (3-HP(M)A), 4-hydroxybutyl (meth)acrylate (4-HB(M)A), 2-butoxyethyl (meth)acrylate, 1,6-hexanediol di(meth)acrylate (HDD(M)A), cyclic trimethylolpropane formal (meth)acrylate (CTF(M)A), 2-phenoxyethyl (meth)acrylate (PHE(M)A), tetrahydrofurfuryl (meth)acrylate (THF(M)A), lauryl (meth)acrylate (L(M)A), diethylene glycol di(meth)acrylate (DEGD(M)A), dipropylene glycol di(meth)acrylate (DPGD(M)A), tripropylene glycol di(meth)acrylate (TPGD(M)A), isobornyl (meth)acrylate (IBO(M)A) or combinations thereof.

The suitable initiator of the present acrylic-based hard coating composition can be selected from those commonly used in the related art, such as, but not limited to, acetophenones, diphenylketones, propiophenones, benzophenones, α-hydroxyketones, fluorenylphosphine oxides and the like. The above-mentioned initiators can be used alone or in combination.

In other embodiments of the present invention, additive, such as antistatic agents, colorants, flame retardants, ultraviolet absorbers, antioxidants or surface modifiers can be added to the aforementioned acrylic-based hard coating composition as required.

Other optical functional layers, for example, a low-refractive layer to provide anti-reflection, can also optionally be applied on the present anti-glare film.

The method for preparing the present anti-glare film comprises the steps of, mixing the polyurethane (meth)acrylate oligomer with a functionality of 6 to 15, at least one of the (meth)acrylate monomer with a functionality of 3 to 6, at least one of the (meth)acrylate monomer with a functionality less than 3, the initiator and the suitable solvent evenly to form the acrylic-based hard coating composition; adding the organic microparticles and/or silica nanoparticles, leveling agents, additives and organic solvents to the acrylic-based hard coating composition, and furtherly mixing evenly to form the anti-glare hard coating solution; coating the anti-glare hard coating solution on the transparent substrate and drying the coated substrate; and curing the coated substrate via radiation or electron beam to form an anti-glare hard coating layer on the substrate to obtain the anti-glare film.

The solvents suitable for preparation of the present anti-glare film can be the organic solvents commonly used in the related art, such as ketones, aliphatic, cycloaliphatic or aromatic hydrocarbons, ethers, esters or alcohols. One or more organic solvents can be used in the acrylic-based hard coating composition. The suitable organic solvent can be such as, acetone, butanone, cyclohexanone, methyl isobutyl ketone, hexane, cyclohexane, dichloromethane, dichloroethane, toluene, xylene, propylene glycol methyl ether, methyl acetate, ethyl acetate, propyl acetate, butyl acetate, n-butanol, isobutanol, isopropanol, diacetone alcohol, propylene glycol methyl ether acetate, cyclohexanol or tetrahydrofuran and the likes, but not limited thereto.

The above-mentioned anti-glare hard coating solution can be applied to the substrate surface by any method known in the related art, for example, bar coating, doctor blade coating, dip coating, roll coating, spinning coating, slot-die coating and the like.

The present anti-glare film can be combined with other functional optical films to form a composite optical film. A functional optical film that can be used is, for example, a polarizer, where the polarizer can be located on the other side of the transparent substrate of the anti-glare film opposite to the anti-glare hard coating layer.

According to the present anti-glare film disclosed, in another embodiment of the present invention, there is further provided a polarizer comprising the polarizing element and the anti-glare film as above formed thereon.

The above and other aspects of the invention will become better understood with regard to the following detailed description of the preferred but non-limiting embodiment(s). These and other aspects of the invention will become apparent from the following description of the presently preferred embodiments. The detailed description is merely illustrative of the invention and does not limit the scope of the invention, which is defined by the appended claims and equivalents thereof. As would be obvious to one skilled in the art, many variations and modifications of the invention may be affected without departing from the spirit and scope of the novel concepts of the disclosure.

### EXAMPLE

### Preparation Example 1: Preparation of Acrylic-Based Hard Coating Composition I

42 weight percent of polyurethane acrylate (the functionality of 6, the viscosity at 25° C. is about 30,000 cps, available from IGM Resins International Trading Taiwan Ltd., Taiwan), 4.5 weight percent of pentaerythritol triacrylate (PETA), 12 weight percent of dipentaerythritol hexaacrylate (DPHA), 3 weight percent cyclotrimethylolpropane methylal acrylate (CTFA), 4 weight percent of initiator (Chemcure-481, available from Chembridge International Co., Ltd., Taiwan), 24.5 weight percent of ethyl acetate (EAC) and 10 weight percent of n-butyl acetate (nBAC) were mixed for 1 hour to form an acrylic-based hard coating composition I.

### Preparation Example 2: Preparation of Acrylic-Based Hard Coating Composition II

40.5 weight percent of polyurethane acrylate (the functionality of 9, the molecular weight is about 2,000, the viscosity at 25° C. is about 86,000 cps, available from Allnex, US), 4.5 weight percent of pentaerythritol triacrylate (PETA), 10.5 weight percent of dipentaerythritol hexaacrylate (DPHA), 4.5 weight percent hexanediol diacrylate (HDDA), 1.5 weight percent 2-phenoxyethyl acrylate (PHEA), 3.5 weight percent of initiator (Chemcure-481), 3.5 weight percent of photoinitiator (TR-PPI-ONE, available from Tronly Enterprise Co., Ltd., Hong Kong), 24.5 weight percent of ethyl acetate (EAC) and 10 weight percent of n-butyl acetate (nBAC) were mixed for 1 hour to form an acrylic-based hard coating composition II.

### Example 1

199 parts by weight of the hard coating composition I, 7.4 parts by weight of hydrophobic-modified silica nanoparticle dispersion sol (NanoBYK-3650, solid content 31%, solvent: propylene glycol methyl ether acetate/propylene glycol monomethyl ether, available from BYK, Germany), 5.3 parts by weight of polyether-modified polydimethylsiloxane leveling agent (BYK-333, solid content 10%, solvent: ethyl acetate, available from BYK, Germany), 19.6 parts by weight of polystyrene microparticles (SSX-303ABE, average particle size 3.0 μm, refractive index 1.59, available from Sekisui Plastics Co., Ltd., Japan), 48.3 parts by weight of propylene glycol methyl ether acetate (PMA) and 100 weight percent of n-butyl acetate (nBAC) were mixed for 1 hour to form an anti-glare hard coating solution.

The prepared anti-glare hard coating solution was coated on a surface of the polyethylene terephthalate (PET) substrate thickness of 80 μm, and then the coated substrate was dried and was cured by UV lamp with a radiation dose of 80 mJ/cm² under a nitrogen atmosphere. Thus, an anti-glare film comprising an anti-glare hard coating layer with a thickness of 4.2 μm formed on a surface of the PET substrate was obtained.

The properties of the obtained anti-glare film were determined in accordance with the measurement described hereinafter. The test results of light transmittance, total haze, internal haze, surface haze, gloss, clarity and anti-glare evaluation were shown in Table 1, and the test results of abrasion resistance, hardness and adhesion were shown in Table 2.

### Example 2

199 parts by weight of the hard coating composition II, 0.5 parts by weight of hydrophobic-modified silica nanoparticle dispersion sol (NanoBYK-3650), 5.2 parts by weight of polyether-modified polydimethylsiloxane leveling agent (BYK-333), 16.3 parts by weight of polystyrene microparticles (XX-35IK, average particle size 3.8 μm, refractive index 1.59, available from Sekisui Plastics Co., Ltd., Japan), 37.4 parts by weight of ether acetate (EAC) and 112 weight percent of methyl isobutyl ketone (MIBK) were mixed for 1 hour to form an anti-glare hard coating layer solution.

The prepared anti-glare hard coating solution was coated on a surface of the polyethylene terephthalate (PET) substrate of thickness of 80 μm, and then the coated substrate was dried and was cured by UV lamp with a radiation dose of 80 mJ/cm² under a nitrogen atmosphere. Thus, an anti-glare film comprising the an anti-glare hard coating layer with a thickness of 5.0 μm formed on a surface of the PET substrate was obtained.

The properties of the obtained anti-glare film were determined as in Example 1, and the test results were shown in Table 1 and 2.

### Example 3

212 parts by weight of the hard coating composition II, 21.6 parts by weight of silica nanoparticle dispersion sol (MEK-9130X, solid content 30%, solvent: butanone, available from Evonik United Silica Industrial Ltd., Taiwan), 5.4 parts by weight of polyether-modified polydimethylsiloxane leveling agent (BYK-307, solid content 10%, solvent: ethyl acetate, available from BYK, Germany), 16.2 parts by weight of polystyrene microparticles (XX-29IK, average particle size 3.5 μm, refractive index 1.59, available from Sekisui Plastics Co., Ltd., Japan), 39.45 parts by weight of n-propyl acetate (nBAC), 39.45 parts by weight of n-butyl acetate (nPAC) and 72.5 weight percent of methyl isobutyl ketone (MIBK) were mixed for 1 hour to form an anti-glare hard coating solution.

The prepared anti-glare hard coating solution was coated on a surface of the polyethylene terephthalate (PET) substrate of thickness of 80 μm, and then the coated substrate was dried and was cured by UV lamp with a radiation dose of 80 mJ/cm² under a nitrogen atmosphere. Thus, an anti-glare film comprising an anti-glare hard coating layer with a thickness of 4.4 μm formed on a surface of the PET substrate was obtained.

The properties of the obtained anti-glare film were determined as in Example 1, and the test results were shown in Table 1 and 2.

### Example 4

199 parts by weight of the hard coating composition II, 3.6 parts by weight of hydrophobic-modified silica nanoparticle dispersion sol (NanoBYK-3650), 5.3 parts by weight of polyether-modified polydimethylsiloxane leveling agent (BYK-333), 16.3 parts by weight of polystyrene microparticles (SSX-303ABE), 36.8 weight percent of ethyl acetate (EAC) and 112 weight percent of methyl isobutyl ketone (MIBK) were mixed for 1 hour to form an anti-glare hard coating solution.

The prepared anti-glare hard coating solution was coated on a surface of the polyethylene terephthalate (PET) substrate of thickness of 80 μm, and then the coated substrate was dried and was cured by UV lamp with a radiation dose of 80 mJ/cm² under a nitrogen atmosphere. Thus, an anti-glare film comprising an anti-glare hard coating layer with a thickness of 4.3 μm formed on a surface of the PET substrate was obtained.

The properties of the obtained anti-glare film were determined as in Example 1, and the test results were shown in Table 1 and 2.

### Example 5

212 parts by weight of the hard coating composition II, 32.4 parts by weight of silica nanoparticle dispersion sol (MEK-9130X), 5.4 parts by weight of polyether-modified polydimethylsiloxane leveling agent (BYK-307), 13 parts by weight of polystyrene microparticles (XX-31IK, average particle size 3.8 μm, refractive index 1.59, available from Sekisui Plastics Co., Ltd., Japan), 39.45 parts by weight of n-propyl acetate (nBAC), 39.45 parts by weight of n-butyl acetate (nPAC) and 72.5 weight percent of methyl isobutyl ketone (MIBK) were mixed for 1 hour to form an anti-glare hard coating solution.

The prepared anti-glare hard coating solution was coated on a surface of the polyethylene terephthalate (PET) substrate of thickness of 80 μm, and then the coated substrate was dried and was cured by UV lamp with a radiation dose of 80 mJ/cm² under a nitrogen atmosphere. Thus, an anti-glare film comprising an anti-glare hard coating layer with a thickness of 4.6 μm formed on a surface of the PET substrate was obtained.

The properties of the obtained anti-glare film were determined as in Example 1, and the test results were shown in Table 1 and 2.

Optical Properties Measurement

The optical properties of the anti-glare films obtained from the Examples were measured according to Japanese Industrial Standard (JIS) test methods.

Light transmittance measurement: The light transmittance was measured according to the test method of JIS K7361 by NDH-2000 Haze Meter (manufactured by Nippon Denshoku Industries, Japan).

Total haze measurement: The total haze was measured according to the test method of JIS K7136 by NDH-2000 Haze Meter.

Internal haze and surface haze measurement: The anti-glare films adhered to a triacetyl cellulose substrate with transparent optical adhesive (T40UZ, thickness 40 μm, available from Fujifilm, Japan), flattening the uneven surface of the anti-glare film. In this state, the haze of prepared sample was measured according to the test method of JIS K7136 by NDH-2000 Haze Meter was the internal haze, and the surface haze could be obtained from the total haze deducted the internal haze.

Gloss measurement: The gloss of the anti-glare films were obtained by adhering the anti-glare films to a black acrylic plate and measuring the gloss thereof according to the test method of JIS Z8741 by BYK Micro-Gloss gloss meter at viewing angles of 20, 60 and 85 degrees.

Clarity measurement: Measuring the anti-glare film according to the test method of JIS K7374 by SUGA ICM-IT image clarity meter, and the sum of the measured values at slits of 0.125 mm, 0.25 mm, 0.50 mm, 1.00 mm and 2.00 mm was the clarity.

Anti-glare evaluation: The anti-glare films were adhered to a black acrylic plate, and the surfaces of the prepared samples were illuminated by 2 fluorescent tubes to check the status of reflected by observation. The evaluation criteria were as below.

Lv.1: Two separate fluorescent tubes could be seen clearly and the straight outlines of tubes was distinguished obviously;
Lv.2: Two separate fluorescent tubes could be seen clearly, but the outlines of tubes were slightly fuzzy;
Lv.3: Two separate fluorescent tubes could be seen, and although the outlines of tubes were slightly fuzzy but the shapes of tubes could be distinguished;
Lv.4: It could be seen that there are 2 fluorescent tubes, but the shapes of tubes could not be distinguished;
Lv.5: It could not be seen that there are 2 fluorescent tubes and the shapes of tubes could not be distinguished.

TABLE 1
The optical properties test results of the anti-
glare films obtained from Examples 1 to 5

| | | Exam- | Exam- | Exam- | Exam- | Exam- |
|---|---|---|---|---|---|---|
| | | ple 1 | ple 2 | ple 3 | ple 4 | ple 5 |
| Light transmittance (%) | | 91.56 | 91.67 | 91.80 | 91.89 | 91.80 |
| Haze | Total haze | 44.30 | 46.89 | 48.20 | 43.77 | 40.30 |
| (%) | Surface haze | 11.42 | 11.89 | 11.90 | 12.20 | 11.15 |
| | Internal haze | 32.88 | 35.00 | 36.30 | 31.57 | 29.15 |
| Gloss | 20° | 8.1 | 6.9 | 9.0 | 8.9 | 10.2 |
| (%) | 60° | 40.7 | 32.8 | 48.8 | 45.6 | 41.3 |
| | 85° | 71.7 | 78.5 | 87.7 | 85.3 | 83.6 |

| | | | | | |
|---|---|---|---|---|---|
| Clarity (%) | 31.7 | 113.2 | 295 | 200 | 293 |
| Anti-glare evaluation | Lv. 4 | Lv. 4 | Lv. 4 | Lv. 4 | Lv. 4 |

Abrasion Resistance, Hardness and Adhesion Test

Abrasion resistance test: The surfaces of the anti-glare films were rubbed by steel wood #0000 with a load of 250 g/cm² for 10 times to check if scratches were made on the film surface by observation.

Hardness test: The hardness was tested according to the test method of JIS K5400 by automatic pencil hardness tester with standard hardness pencil (available from Mitsubishi Pencil, Japan) of hardness 2H, and checked if scratches were made on the surface under 5 times of test by observation. If there had no scratch on the surface, it was marked as “0/5”.

Adhesion test: The adhesion to substrate was tested according to the test method of JIS K 5600-5-6 by cross-cut tester.

TABLE 2
The test results of the anti-glare films obtained from Examples
1 to 5 of abrasion resistance, hardness and adhesion

| | Exam- | Exam- | Exam- | Exam- | Exam- |
|---|---|---|---|---|---|
| | ple 1 | ple 2 | ple 3 | ple 4 | ple 5 |
| Abrasion resistance | 0 | 0 | 0 | 0 | 0 |
| (250 gf/cm²) number | | | | | |
| of scratches were made | | | | | |
| Hardness (2H) | 0/5 | 0/5 | 0/5 | 0/5 | 0/5 |
| Adhesion (%) | 100/100 | 100/100 | 100/100 | 100/100 | 100/100 |

As shown in Table 1 and 2, the present anti-glare films provided good optical properties, good adhesions to a polyethylene terephthalate (PET) substrate, and the present anti-glare films exist excellent abrasion resistances.

Although particular embodiments have been shown and described, it should be understood that the above discussion is not intended to limit the present invention to these embodiments. Persons skilled in the art will understand that various changes and modifications may be made without departing from the scope of the present invention as literally and equivalently covered by the following claims.

What is claimed is:

1. An anti-glare film, comprising:
a transparent substrate; and
an anti-glare hard coating layer formed on a surface of the transparent substrate, wherein the anti-glare hard coating layer comprising:
75 to 90 weight percent of an acrylic-based hard coating composition;
0.01 to 10 weight percent of silica nanoparticles; and
5 to 20 weight percent of organic microparticles;
wherein the gloss of the anti-glare film at a viewing angle of 60 degrees is between 30% and 50%.

2. The anti-glare film as claimed in claim 1, wherein the average particle diameter of the organic microparticles used in the anti-glare hard coating layer is ranging from 1 μm to 6 μm.

3. The anti-glare film as claimed in claim 2, wherein the average particle diameter of the organic microparticles used in the anti-glare hard coating layer is ranging from 2 μm to 5 μm.

4. The anti-glare film as claimed in claim 1, wherein the average primary particle diameter (d₅₀) of the silica nanoparticles used in the anti-glare hard coating layer is ranging from 5 nm to 30 nm and the average secondary particle diameter (d₅₀) thereof is ranging from 50 nm to 120 nm.

5. The anti-glare film as claimed in claim 1, the usage amount of the organic microparticles is ranging between 7 and 15 weight percent.

6. The anti-glare film as claimed in claim 1, wherein the usage amount of the silica nanoparticles is ranging between 0.05 and 7 weight percent.

7. The anti-glare film as claimed in claim 1, wherein the organic microparticles are polymethyl methacrylate resin microparticles, polystyrene resin microparticles, styrene-methyl methacrylate copolymer microparticles, polyethylene resin microparticles, epoxy resin microparticles, silicone resin microparticles, polyvinylidene fluoride resin or polyvinyl fluoride resin microparticles with hydrophilic or hydrophobic surface treatment.

8. The anti-glare film as claimed in claim 1, wherein a leveling agent of 0.05 to 2 weight percent can be further added to the anti-glare hard coating layer.

9. The anti-glare film as claimed in claim 1, wherein the leveling agent is a polyether modified polysiloxane leveling agent.

10. The anti-glare film as claimed in claim 1, wherein the acrylic-based hard coating composition of the anti-glare hard coating layer comprises a (meth)acrylate composition and an initiator, wherein the (meth)acrylate composition comprising;
a polyurethane (meth)acrylate oligomer of 35 to 50 weight percent with a functionality of 6 to 15;
a (meth)acrylate monomer of 12 to 20 weight percent with a functionality of 3 to 6; and
a (meth)acrylate monomer of 1.5 to 12 weight percent with a functionality less than 3

11. The anti-glare film as claimed in claim 10, wherein the polyurethane (meth)acrylate oligomer with a functionality of 6 to 15 is an aliphatic polyurethane (meth)acrylate oligomer with a functionality of 6 to 15.

12. The anti-glare film as claimed in claim 10, wherein the (meth)acrylate monomer with a functionality of 3 to 6 is selected from at least one of a group consisting of pentaerythritol tetra(meth)acrylate, dipentaerythritol penta(meth)acrylate (DPP(M)A), dipentaerythritol hexa(meth)acrylate (DPH(M)A), trimethylolpropane tri(meth)acrylate (TMPT(M)A), ditrimethylolpropane tetra(meth)acrylate (DTMPT(M)A), pentaerythritol tri(meth)acrylate (PET(M)A), or combinations thereof.

13. The anti-glare film as claimed in claim 10, wherein the (meth)acrylate monomer with a functionality less than 3 is selected from at least one of a group consisting of 2-ethylhexyl (meth)acrylate (2-EH(M)A), 2-hydroxyethyl (meth)acrylate (2-HE(M)A), 3-hydroxypropyl (meth)acrylate (3-HP(M)A), 4-hydroxybutyl (meth)acrylate (4-HB(M)A), 2-butoxyethyl (meth)acrylate, 1,6-hexanediol di(meth)acrylate (HDD(M)A), cyclic trimethylolpropane formal (meth)acrylate (CTF(M)A), 2-phenoxyethyl (meth)acrylate (PHE(M)A), tetrahydrofurfuryl (meth)acrylate (THF(M)A), lauryl (meth)acrylate (L(M)A), diethylene glycol di(meth)acrylate (DEGD(M)A), dipropylene glycol di(meth)acrylate (DPGD(M)A), tripropylene glycol di(meth)acrylate (TPGD(M)A), isobornyl (meth)acrylate (IBO(M)A) or combinations thereof.

14. The anti-glare film as claimed in claim 10, wherein the initiator is selected from at least one of a group consisting of acetophenones initiator, diphenylketones initiator, propiophenones initiator, benzophenones initiator, α-hydroxyketones initiator, fluorenylphosphine oxides initiator or combinations thereof.

15. A polarizer comprising a polarizing element, wherein an anti-glare film as claimed in claim 1 is formed on a surface of the polarizing element of the polarizer.
